(19) United States
(12) Patent Application Publication
(10) Pub. No.: US 2023/0328506 A1
(43) Pub. Date: Oct. 12, 2023

(54) Public Private Network Transitions with Single SIM Profile

(71) Applicant: Celona, Inc., Campbell, CA (US)

(72) Inventors: Srinivasan Balasubramanian, San Diego, CA (US); Puneet Prabhakar Shetty, San Francisco, CA (US)

(21) Appl. No.: 18/295,638

(22) Filed: Apr. 4, 2023

Related U.S. Application Data
(60) Provisional application No. 63/328,132, filed on Apr. 6, 2022.

(51) Int. Cl. H04W 8/18; H04W 8/00; H04L 61/2596

(52) U.S. Cl. CPC H04W 8/183; H04L 2101/654; H04L 61/2596; H04W 8/005

(57) ABSTRACT

The present disclosure provides an automotive solution operating with the following constraints: (1) provide connectivity to public MNO network and private enterprise network; (2) support both public and private domain connectivity with a single SIM profile; (3) both public and private connectivity using independent IMSI and credentials; (4) UE using the appropriate IMSI when connecting to the public and private networks; (5) a break-before-make for transitions across public and private networks; (6) continuity of service across the two domains is not required; and (7) if private network services need to be accessed from public network, explicit VPN style tunneling will support that function.

### CLAIM OF PRIORITY TO PREVIOUSLY FILED PROVISIONAL APPLICATION—INCORPORATION BY REFERENCE

This non-provisional application claims priority to an earlier-filed provisional application No. 63/328,132 filed Apr. 6, 2022, entitled “Public Private Network Transitions with Single SIM Profile” (ATTY DOCKET NO. CEL-087-PROV) and the provisional application No. 63/328,132 filed Apr. 6, 2022, and all its contents, are hereby incorporated by reference herein as if set forth in full.

### BACKGROUND

### (1) Technical Field

The disclosed method and apparatus relate generally to wireless communications systems. In particular, the disclosed method and apparatus relate to management of International Mobile Subscriber Identity (IMSI) data in public and private networks.

### (2) Background

In today's wireless communication networks, various types of identifiers are used to manage access to the communications network. In particular, User Equipment (UEs) and network base station/access points (BS/APs) have various identifiers associated with them to uniquely identify each UE and BS/AP, etc.

FIG. 1 is an illustration of the identifiers used in some communications networks. FIG. 2 is an illustration of additional identifiers for a Citizen Band Radio System (CBRS). FIG. 3 shows a breakdown of some of the identifiers. FIG. 4 identifies some of the information used by a UE to select a system that the UE will wirelessly access.

### Available System Selection Mechanisms

System Selection

Single PLMN: This is the typical configuration used by most MNOs. The LTE SIB will transmit a single PLMN that the UEs can use to identify the system to camp.

MOCN: Multi-Operator Core Network. This mechanism uses the LTE SIBs and allows for supporting multiple PLMNs from a single eNB. UEs use the preferred PLMN amongst the list broadcasted to enter the system. Enterprise LTE RAN is connected to multiple MNO core networks via the S1. MME is also shared between the MNOs.

HPLPLMN Scan

A UE, when camped on a lower preferred system, periodically looks for an available higher priority system, restricting the scans to the MCC of the currently camped system.

EHPLMN

When the UE looks for available networks, it will look for the most preferred system within the defined EHPLMN list before camping on a specific system. Once the UE is camped on a PLMN from the EHPLMN, it is in an equivalent home system and further prioritization within the EHPLMN list is not employed.

### Available System Selection Mechanisms

Manual PLMN Scans

The UE scans for all available systems based on the RF bands supported by the UE. This list of system names are presented for a specific selection from the list to be made.

Such a manual scan can be initiated by the user, specialized smartphone app developed for this purpose, or realized as a feature in the HLOS.

DSDS (Dual SIM Dual Standby)

A DSDS system is characterized by Dual-Rx & Single-Tx. The UE performs camping for data and voice services based on the user's preferences supporting data and voice on the appropriate credentials based on the current network coverage of the different systems. Typically, the primary SIM is a hard SIM and the secondary SIM is one of the eSIM credentials provisioned in the device. Behaviors are subject to locked and unlocked devices.

NAS Reject

The EMM reject used when the UE uses an IMSI that does not belong to the network:
ATTACH REJECT
TRACKING AREA UPDATE REJECT and
SERVICE REJECT.

EMM cause #15 is sent to the UE if it requests tracking area updating in a tracking area where the UE, by subscription, is not allowed to operate, but when it should find another allowed tracking area in the same PLMN. The UE shall store this TAC in the list of “forbidden tracking areas for roaming”. This list shall be erased when the UE is switched off or when the UICC containing the USIM is removed, and periodically (with a period in the range 12 to 24 hours) or after a subsequent procedure e.g., attach procedure, tracking area updating procedure and GUTI reallocation procedure, one or more tracking areas in the lists is received from the network. NOTE: Cause #15 and cause #12 differ in the fact that cause #12 does not trigger the UE to search for another allowed tracking area on the same PLMN.

### Need for Managing PCIs

LTE network needs not only good RSRP levels, but also high Signal to Interference plus Noise Ratio (SINR).

If PCI is not planned well, it will cause high interruption of the Reference Signal (RS).

This situation may then result in an effective lack of signal coverage.

To assign PCI correctly and efficiently will increase resource utilization and QoS of the LTE system for subscribers.

Poor planning results in PCI conflicts or collisions which impact network performance.

PCI is used by User Equipment (UE) to identify a specific small cell. In addition, PCI is one of the most important parameters in the configuration process in SON.

The number of unique PCIs that been supported in macro cell is 504 due to the needs of compatibility with legacy base station. Reuse PCIs is normal, e.g., that our task is deploying a LTE network in an urban area that needs 1500 cells, where each of the 1500 cells have to have their own cell ID. Since there are only 504 physical cell IDs (PCI), then reusing the PCIs is inevitable, where in this case, each PCI must be used for three times. The three cells that share the same PCI must not be geographically close to each other, and by not doing so that may bring along with it an interference problems.

### PCI Values

PCIs, or Physical Cell Identifiers, in LTE networks provide a psuedo-unique value for identifying eNodeBs. The PCI value is created from two components—PSS and SSS. The PSS, Primary Synchronization Signal, has the value 0, 1, or 2. The SSS, Secondary Synchronization Signal, can have a value between 0 and 167. The PCI value is [(3×SSS)+(PSS)], resulting in a value between 0 and 503. In some cases, computing PCI from PSS&SSS and PSS&SSS from PCI. With only these 504 values, PCIs are reused in the network and planning reuse, reuse strategy, options, etc. requires a defined algorithm to manage.

### PCI Conflicts

PCI Collision occurs when a UE is in the coverage of two cells which has the same PCI value. In some cases, PCI Collision occurs when two direct neighbor cells have same PCI as serving cell. The industry standard TS 36.902 defines “collision-free” as when a PCI is unique in the cell area that it covers. When a PCI collision occurs, a UE may not be able to access either of the two cells due to the interference generated.

PCI Confusion occurs when an eNB discovers two neighbors with the same PCI value. The industry standard TS 36.902 defines “confusion-free” as a condition that occurs if a cell does not have neighboring cells with an identical PCI. PCI confusion may lead to high number of handover failures and call drops.

### 3GPP Suggested Approach for PCI Allocation

A base station tries to get a valid range of PCIs from the OAM. The list of returned PCIs depends on the location of the deployment and the operator's planning policies. The base station performs neighbor discovery through a broadcasting mechanisms (REM/NMM) to detect the PCIs of its neighbor cells, thus avoiding selecting these PCIs. The X2 interface enables neighbors to exchange a neighbor relation table that contains information about neighbors of neighbors. Therefore, the base station may avoid selecting PCIs that result in confusion. The base station selects a random PCI from the list of candidate PCIs. The base station then sends the selected PCI to the OAM that records this configuration.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of the identifiers used in some communications networks.

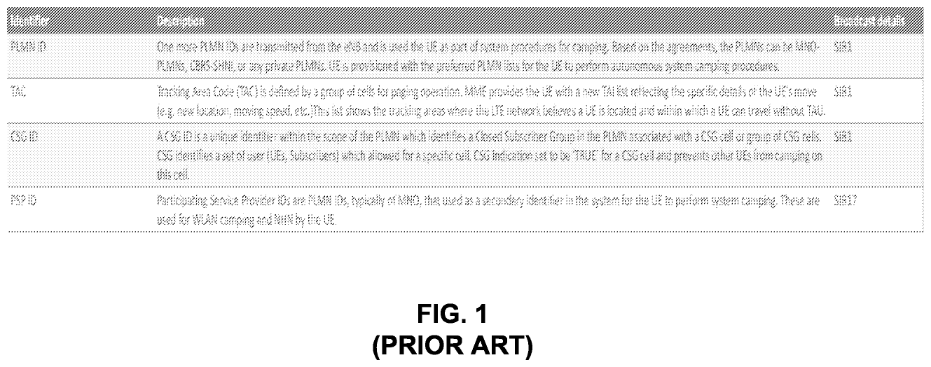

FIG. 2 is an illustration of additional identifiers for a Citizen Band Radio System (CBRS).

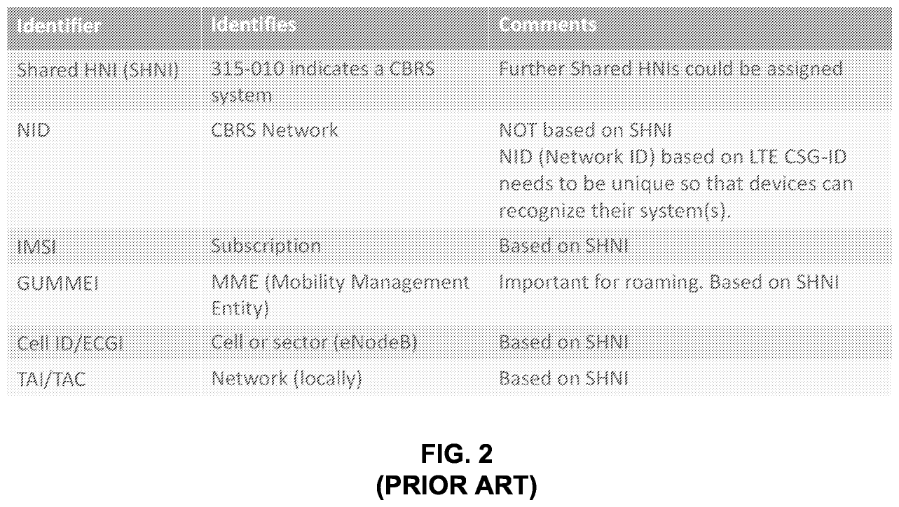

FIG. 3 shows a breakdown of some of the identifiers.

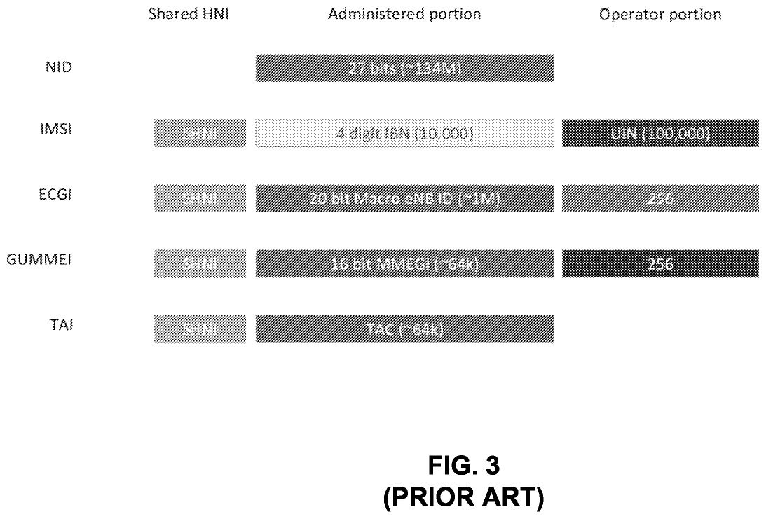

FIG. 4 identifies some of the information used by a UE to select a system that the UE will wirelessly access.

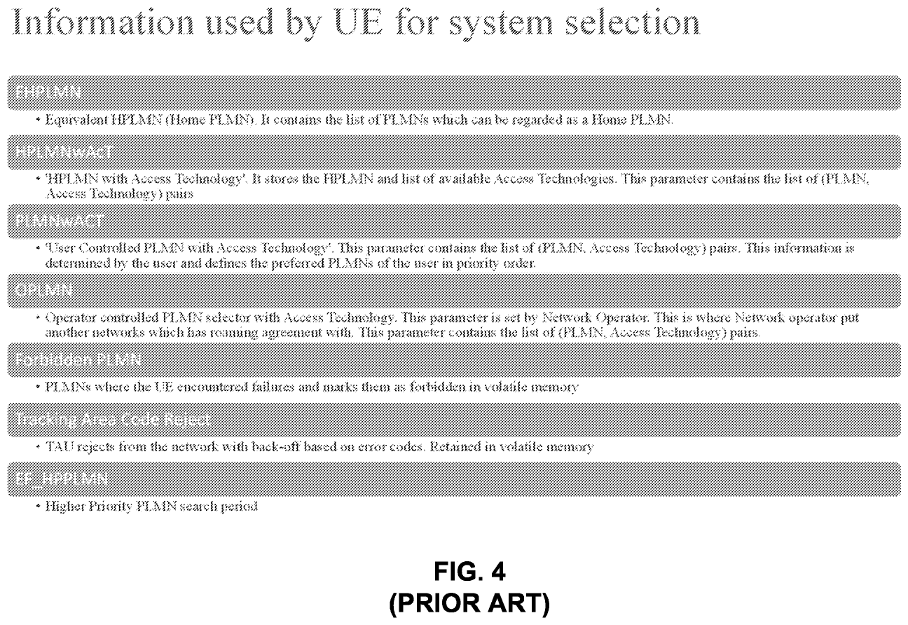

FIG. 5 shows several situations in which the UE transitions.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The present disclosure provides an automotive solution operating with the following constraints: (1) provide connectivity to public MNO network and private enterprise network; (2) Support both public and private domain connectivity with a single SIM profile; (3) The public and private connectivity will each use independent IMSI and credentials; (4) the UE needs to use the appropriate IMSI when connecting to the public and private networks; (5) a break-before-make for transitions across public and private networks is sufficient; (6) continuity of service across the two domains is not required; and (7) if private network services need to be accessed from public network, explicit VPN style tunneling will be supported to support that function.

The present disclosure provides a method and apparatus for switching across Public and Private networks. In some embodiments, the EHPLMN is provisioned with the private network PLMN-ID(s). In some embodiments, the OPLMN is provisioned with the public network PLMN-ID(s). In some embodiments, the HPPLMN (higher priority PLMN) scan procedure supported in the modem is leveraged. In some such embodiments, the focus is on looking for more preferred systems to transitioning from OPLMN to EHPLMN. When the UE leaves the footprint of the private network, the UE will transition to find the OPLMN entries. The disclosed approach addresses both public and private networks supported, such as LTE or 5G NR networks.

In some embodiment in which the private network supports Neutral Host operations of the Public network PLMN, the UE may transition into the enterprise network with the public network PLMN. However, similar to inter network transitions, the UE will transition from neutral host camping to private network camping on the same private network cell using the HPPLMN scan procedures. In some embodiments, when camped on the Public network based on the OPLMN entries, the roaming indications are suppressed from the user interface. In some such embodiments, the roaming indication can be suppressed from the network by providing a EPLMN (equivalent PLMN) indication at the NAS layer. This may require a change from the public network but may be implicitly enabled.

### Process for Switching IMSI

Some embodiments of the disclosed method and apparatus include a process for switching IMSI on transitions across public and private network which includes the following:

Approach A: UE attaches the current IMSI. Upon receiving an Attach failure due to authentication failure, the SIM card receives the error code; The SIM card switches the IMSI and attempts to Attach to the network with the alternative IMSI

Approach B: UE provides the information of the PLMN it is connecting to the SIM card. This can be done either when: Option 1: the modem senses a change of PLMN; or Option 2: when the authentication challenge comes in and the request for addressing the challenge is forwarded to the SIM card.

### Illustrative Transitions Across Public and Private Networks

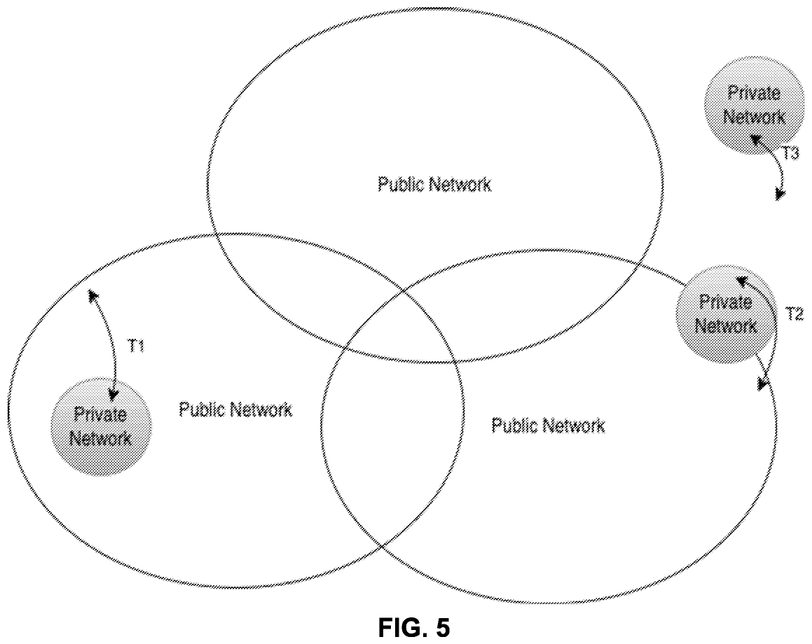

FIG. 5 shows several situations in which the UE transitions.

T1: Transitions with both public and private network in coverage.

T2: Transitions with partial public network and in private network coverage.

T3: Transition with no public network coverage and in private network coverage.

The disclosed method and apparatus address all the above transitions.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A communication system for managing transitions using one subscriber identification module (SIM), the system comprising:
a) An HPPLMN configured to perform scan procedures to transition across public and private networks using a single SIM profile and to associate independent International Mobile Subscriber Identity (IMSI) values for the public and private networks; and
b) A module for defining triggers for switching to use an appropriate IMSI associated with the public and private networks.
